(19) United States
(12) Patent Application Publication
(10) Pub. No.: US 2025/0125462 A1
(43) Pub. Date: Apr. 17, 2025

(54) BUSBAR ASSEMBLY FOR ARRAYS OF BATTERY CELLS

(71) Applicant: Molex, LLC, Lisle, IL (US)

(72) Inventor: Ronald C Hodge, Montgomery, IL (US)

(21) Appl. No.: 18/681,067

(22) PCT Filed: Aug. 10, 2022
(86) PCT No.: PCT/IB2022/057461

§ 371 Date: Feb. 5, 2024

Related U.S. Application Data
(60) Provisional application No. 63/239,528, filed on Sep. 1, 2021.

(51) Int. Cl. H01M 50/213; H01M 10/6554; H01M 50/503; H01M 50/507; H01M 50/593

(52) U.S. Cl. CPC H01M 50/213; H01M 10/6554; H01M 50/503; H01M 50/507; H01M 50/593

(57) ABSTRACT

A busbar assembly includes a first conductive busbar having an opening therethrough and a first spring contact extending therefrom, a second conductive busbar having a second spring contact extending therefrom, wherein the second spring contact extends through the opening, and an insulative member between the first and second conductive busbars. A plurality of the openings, the first spring contacts and the second spring contacts are provided as part of the assembly.

### RELATED APPLICATIONS

This application claims priority to U.S. Provisional Application No. 63/239,528 filed Sep. 1, 2021, which is incorporated herein by reference.

### FIELD OF THE DISCLOSURE

The present disclosure is directed to a busbar assembly.

### DESCRIPTION OF RELATED ART

Busbar assemblies have been used to connect individual battery cells together in an array of battery cells, and are commonly used in electric vehicles (EV). The busbars which connect the battery cells are used to distribute electric power to an electric motor that drives the electric vehicle, as well as various other electrical components of the electric vehicle. The assembly of the busbar assembly to the battery cells can be complex. Accordingly, an assembly which provides for an easier assembly of the busbar assembly to the battery cells, while still ensuring proper electrical connections between the busbar assembly and the battery cells is desirable.

### BRIEF SUMMARY

Accordingly, the present disclosure provides an improved busbar assembly.

In an embodiment, a busbar assembly includes a first conductive busbar having an opening therethrough and a first spring contact extending therefrom, a second conductive busbar having a second spring contact extending therefrom, wherein the second spring contact extends through the opening, and an insulative member between the first and second conductive busbars. A plurality of the openings, the first spring contacts and the second spring contacts are provided as part of the assembly.

In an embodiment, a busbar assembly includes a first conductive busbar having an opening therethrough and a first spring contact extending therefrom, an input electrically coupled to the first busbar, a second conductive busbar having a second spring contact extending therefrom, wherein the second spring contact extends through the opening and nests within the first spring contact, an insulative member between the first and second conductive busbars. A plurality of the openings, the first spring contacts and the second spring contacts are provided as part of the assembly. Each first spring contact is configured to engage with a negative terminal of a respective battery cell of a first array of battery cells, and each second spring contact is configured to engage with a positive terminal of the respective battery cell. The busbar assembly further includes a third conductive busbar having an opening therethrough and a third spring contact extending therefrom, a fourth conductive busbar having a fourth spring contact extending therefrom, wherein the fourth spring contact extends through the opening in the third conductive busbar and nests within the third spring contact, and an insulative member between the third and fourth conductive busbars. A plurality of openings in the third conductive busbar, the third spring contacts and the fourth spring contacts are provided as part of the assembly. Each third spring contact is configured to engage with a negative terminal of a respective battery cell of a second array of battery cells, and each fourth spring contact is configured to engage with a positive terminal of the respective battery cell of the second array. A coupling electrically connects the second busbar to the third busbar. An output is electrically coupled to the third busbar. A first insulative bracket is engaged against the second busbar, and a position of the insulative bracket can be adjusted relative to the first and second busbars. A second insulative bracket is engaged against the fourth busbar, and a position of the second insulative bracket can be adjusted relative to the third and fourth busbars.

### BRIEF DESCRIPTION OF THE DRAWINGS

The present disclosure is illustrated by way of example, and not limited, in the accompanying figures in which like reference numerals indicate similar elements and in which:

FIGS. 1 and 2 depict perspective views of a busbar assembly mounted to arrays of battery cells;

FIG. 3 is a cross-sectional view along line 3-3 of FIG. 1;

FIG. 4 is a cross-sectional view along line 4-4 of FIG. 1;

FIG. 5 is a partial perspective view of a portion of the busbar assembly; and

FIGS. 6 and 7 are partial plan views of portions of the busbar assembly.

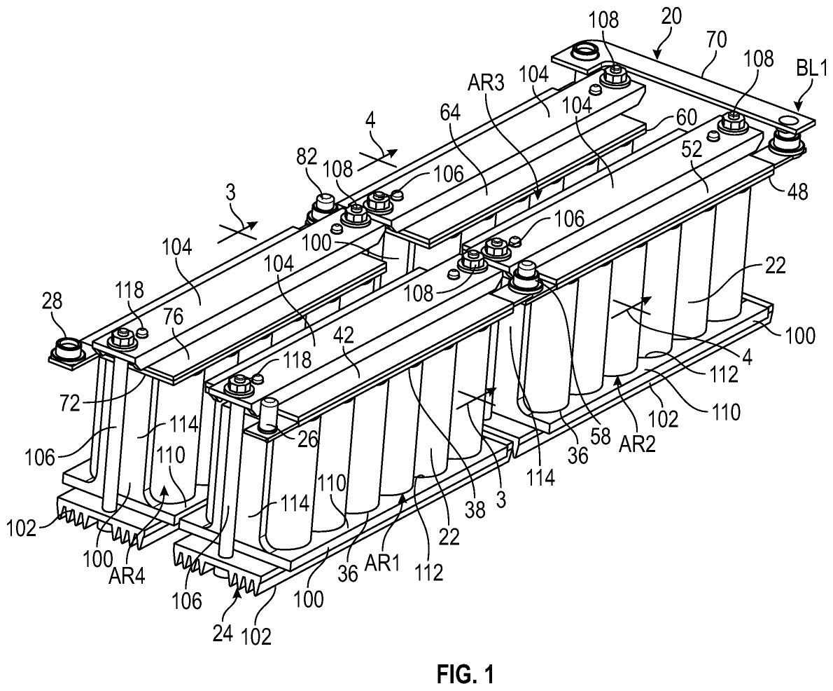

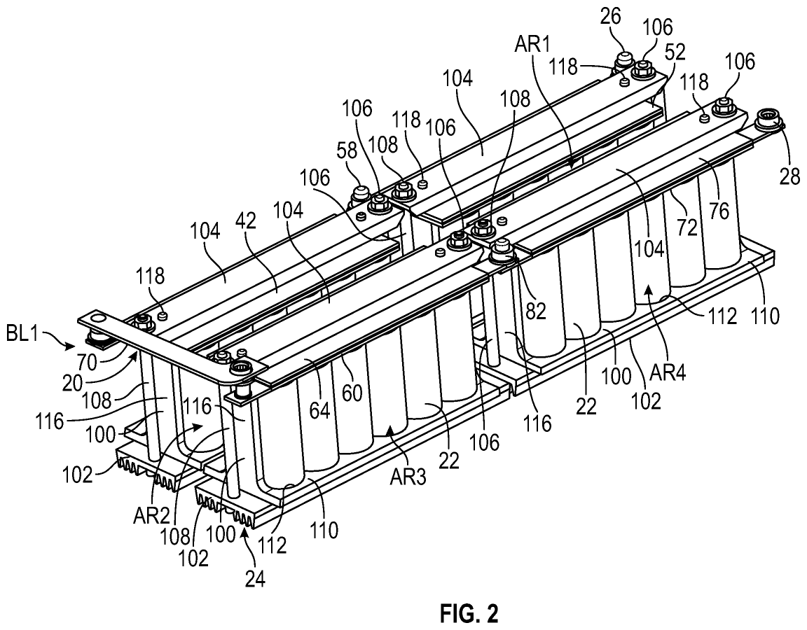

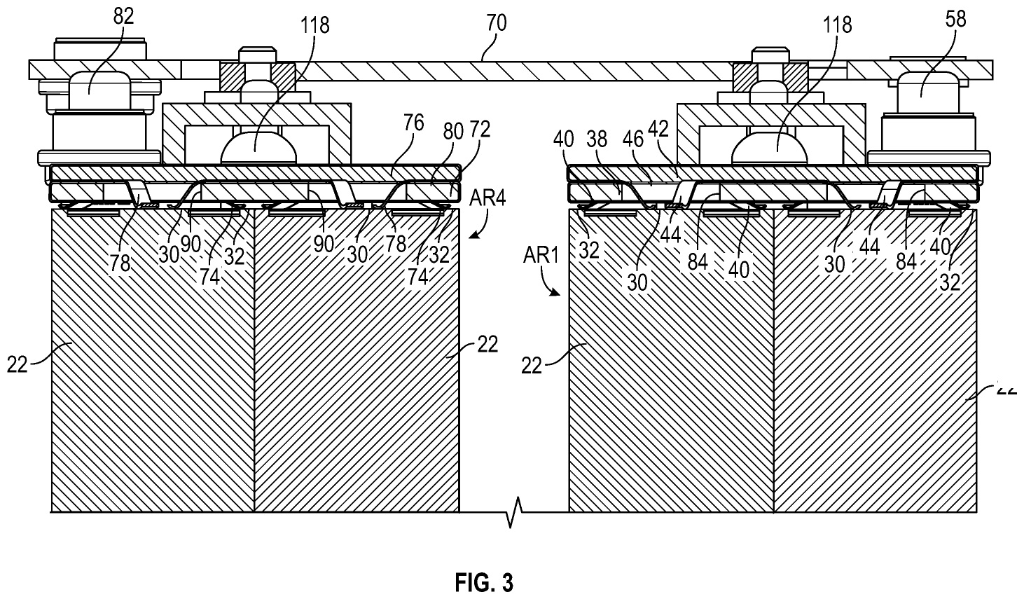

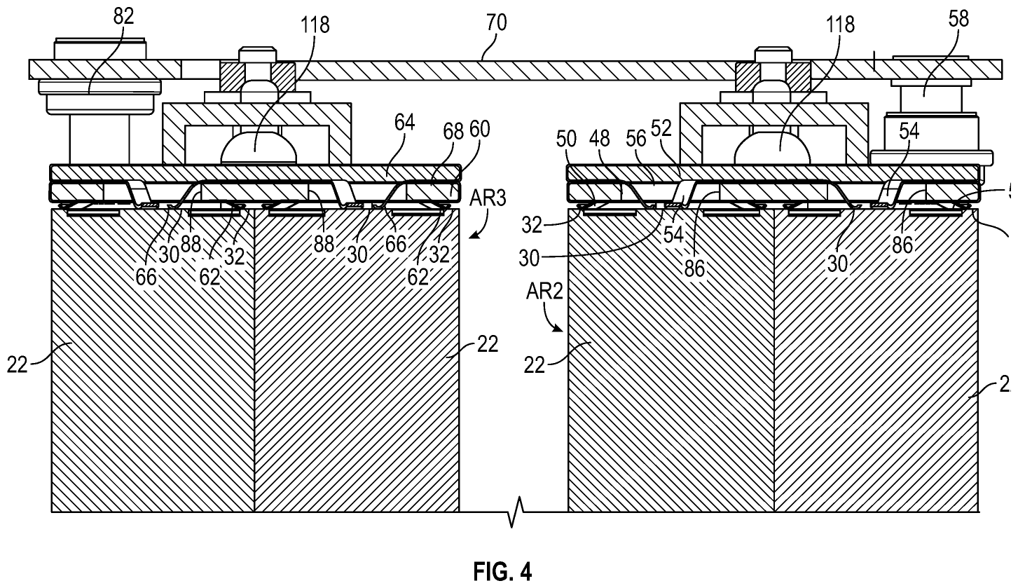

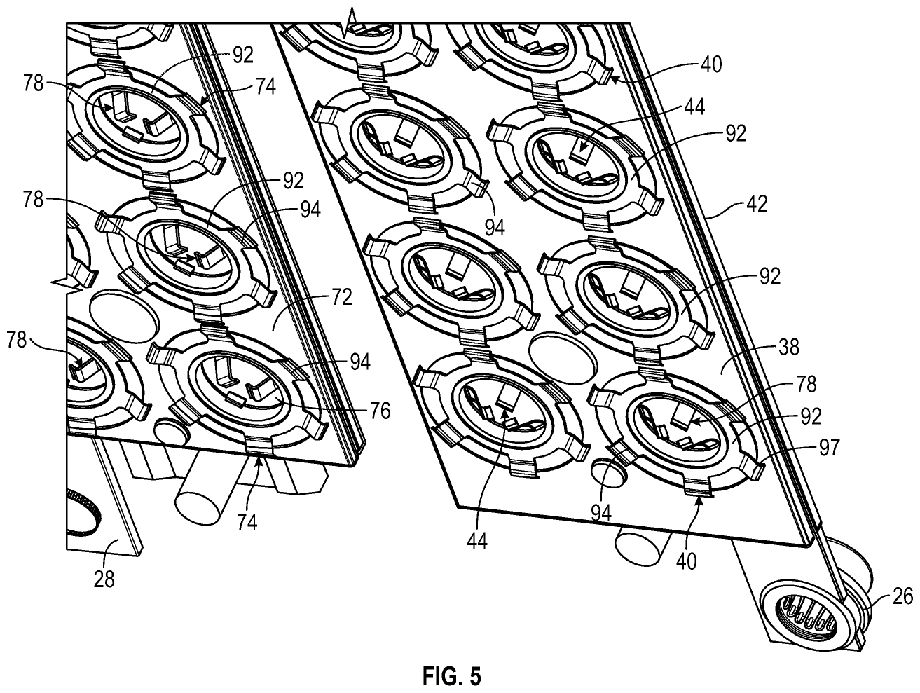

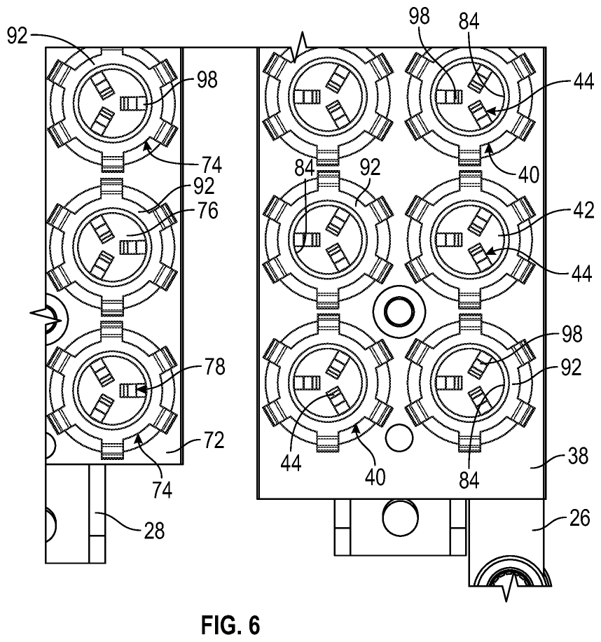

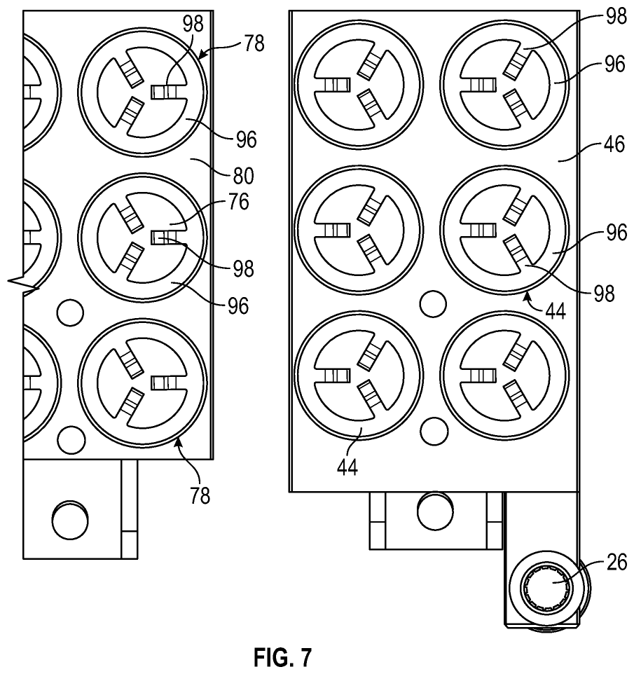

### DETAILED DESCRIPTION

The appended drawings illustrate embodiments of the present disclosure and it is to be understood that the disclosed embodiments are merely exemplary of the disclosure, which may be embodied in various forms. Therefore, specific details disclosed herein are not to be interpreted as limiting, but merely as a basis for the claims and as a representative basis for teaching one skilled in the art to variously employ the present disclosure.

While the disclosure may be susceptible to embodiment in different forms, there is shown in the drawings, and herein will be described in detail, specific embodiments with the understanding that the present disclosure is to be considered an exemplification of the principles of the disclosure, and is not intended to limit the disclosure to that as illustrated and described herein. Therefore, unless otherwise noted, features disclosed herein may be combined to form additional combinations that were not otherwise shown for purposes of brevity. It will be further appreciated that in some embodiments, one or more elements illustrated by way of example in a drawing(s) may be eliminated and/or substituted with alternative elements within the scope of the disclosure.

Directional terms such as front, rear, horizontal, vertical and the like are used for ease in explanation, and do not denote a required orientation in use.

A busbar assembly 20 mounts to arrays of battery cells 22 by a holding assembly 24. As shown, first, second, third and fourth arrays AR1, AR2, AR3, AR4 of battery cells 22 are provided to form a block BL1 of arrays AR1, AR2, AR3, AR4. An input 26 is electrically coupled to an input end of the busbar assembly 20 which overlays the first array AR1, and an output 28 is electrically coupled to an output end of the busbar assembly 20 which overlays the fourth array AR4. While four arrays AR1, AR2, AR3, AR4 are shown, a single array, or at least two arrays can be provided.

Each battery cell 22 is conventional and has a positive terminal 30 surrounded by a negative terminal 32 within a battery case 34. The battery case 34 may be cylindrical. The positive and negative terminals 30, 32 are exposed at the top end of the battery case 34. A lower end 36 of the battery case 34 is planar. In the embodiment as shown, the battery cells 22 in the arrays AR1, AR2, AR3, AR4 are arranged side-by-side in columns and rows. As shown, each array AR1, AR2, AR3, AR4 has six columns and two rows of battery cells 22.

In the embodiment as shown, the busbar assembly 20 includes a first conductive busbar 38 having a plurality of conductive spring contacts 40 thereon coupled to the negative terminals 32 of the battery cells 22 in array AR1, a second conductive busbar 42 having a plurality of conductive spring contacts 44 thereon coupled to the positive terminals 30 of the battery cells 22 in array AR1, an insulator 46 between the busbars 38, 42, a third conductive busbar 48 having a plurality of conductive spring contacts 50 thereon coupled to the negative terminals 32 of the battery cells 22 in array AR2, a fourth conductive busbar 52 having a plurality of conductive spring contacts 54 thereon coupled to the positive terminals 30 of the battery cells 22 in array AR2, an insulator 56 between the busbars 48, 52, a conductive connector 58 coupling the second busbar 42 to the third busbar 48, a fifth conductive busbar 60 having a plurality of conductive spring contacts 62 thereon coupled to the negative terminals 32 of the battery cells 22 in array AR3, a sixth conductive busbar 64 having a plurality of conductive spring contacts 66 thereon coupled to the positive terminals 30 of the battery cells 22 in array AR3, an insulator 68 between the busbars 60, 64, a conductive connector 70 coupling the fourth busbar 52 to the fifth busbar 60, a seventh conductive busbar 72 having a plurality of conductive spring contacts 74 thereon coupled to the negative terminals 32 of the battery cells 22 in array AR4, an eighth conductive busbar 76 having a plurality of conductive spring contacts 78 thereon coupled to the positive terminals 30 of the battery cells 22 in array AR4, an insulator 80 between the busbars 72, 76, and a conductive connector 82 coupling the sixth busbar 64 to the seventh busbar 72. The input 26 is coupled to the first busbar 38, and the output 28 is coupled to the eighth busbar 76. At least one array is provided. For example, a single array AR1 are provided with the input 26 coupled to the first busbar 38 and the output 28 coupled to the second busbar 42. For example, arrays AR1, AR2 are provided with the input 26 coupled to the first busbar 38 and the output 28 coupled to the fourth busbar 52.

Each busbar 38, 42, 48, 52, 60, 64, 72, 76 is rigid and elongated, having parallel upper and lower sides. The lower side of busbar 38 faces the upper ends of the battery cells 22 in array AR1, and the upper side of busbar 38 faces the lower surface of busbar 42, with the insulator 46 therebetween. The busbars 38, 42 and the insulator 46 are permanently affixed together in a sandwich construction, and the insulator 46 prevents electrical communication between the busbars 38, 42. The lower side of busbar 48 faces the upper ends of the battery cells 22 in array AR2, and the upper side of busbar 48 faces the lower surface of busbar 52, with the insulator 56 therebetween. The busbars 48, 52 and the insulator 56 are permanently affixed together in a sandwich construction, and the insulator 56 prevents electrical communication between the busbars 48, 52. The lower side of busbar 60 faces the upper ends of the battery cells 22 in array AR3, and the upper side of busbar 60 faces the lower surface of busbar 64, with the insulator 68 therebetween. The busbars 60, 64 and the insulator 68 are permanently affixed together in a sandwich construction, and the insulator 68 prevents electrical communication between the busbars 60, 64. The lower side of busbar 72 faces the upper ends of the battery cells 22 in array AR4, and the upper side of busbar 72 faces the lower surface of busbar 76, with the insulator 80 therebetween. The busbars 72, 76 and the insulator 80 are permanently affixed together in a sandwich construction, and the insulator 80 prevents electrical communication between the busbars 72, 76.

Busbar 38 has a plurality of spaced apart openings 84 that are configured in the same orientation as the battery cells 22 in the array AR1. When the busbar 38 overlays the battery cells 22 in the array AR1, the openings 84 expose the positive terminals 30 of each battery cell 22 in the array AR1 to the busbar 42. The negative terminals 32 of each battery cell 22 in the array AR1 are not exposed to the busbar 42. Busbar 48 has a plurality of spaced apart openings 86 that are configured in the same orientation as the battery cells 22 in the array AR2. When the busbar 48 overlays the battery cells 22 in the array AR2, the openings 86 expose the positive terminals 30 of each battery cell 22 in the array AR2 to the busbar 52. The negative terminals 32 of each battery cell 22 in the array AR2 are not exposed to the busbar 52. Busbar 60 has a plurality of spaced apart openings 88 that are configured in the same orientation as the battery cells 22 in the array AR3. When the busbar 60 overlays the battery cells 22 in the array AR3, the openings 88 expose the positive terminals 30 of each battery cell 22 in the array AR3 to the busbar 64. The negative terminals 32 of each battery cell 22 in the array AR3 are not exposed to the busbar 64. Busbar 72 has a plurality of spaced apart openings 90 that are configured in the same orientation as the battery cells 22 in the array AR4. When the busbar 72 overlays the battery cells 22 in the array AR4, the openings 90 expose the positive terminals 30 of each battery cell 22 in the array AR4 to the busbar 76. The negative terminals 32 of each battery cell 22 in the array AR4 are not exposed to the busbar 76.

The conductive spring contacts 40, 50, 62, 74 are permanently attached to the lower surfaces of the busbars 38, 48, 60, 72, and may be coupled thereto by welding, laser welding or other metal joining process. Each conductive spring contact 40, 50, 62, 74 is identically formed. Each conductive spring contact 40, 50, 62, 74 includes a rigid circular ring 92 having a plurality of flexible fingers 94 extending downward and outward from the ring 92. The rings 92 are mounted to the lower surfaces of the busbars 38, 48, 60, 72 and each surrounds the respective openings 84, 86, 88, 90. The fingers 94 are spaced apart from each other around the circumference of the respective ring 92 and extend radially outward from the respective ring 92. A lower end of each finger 94 of each spring contact 40, 50, 62, 74 engages with the negative terminal 32 of the respective battery cell 22 in the arrays AR1, AR2, AR3, AR4 when the fingers 94 are deflected as described herein.

The conductive spring contacts 44, 54, 66, 78 are permanently attached to the lower surfaces of the busbars 42, 52, 64, 76, and may be coupled thereto by welding, laser welding or other metal joining process. As described herein, the spring contacts 44 nest within the spring contacts 40; the spring contacts 54 nest within the spring contacts 50; the spring contacts 66 nests within the spring contacts 62; and the spring contacts 78 nests within the spring contacts 74. The spring contacts 40, 50, 62, 74 and the spring contacts 44, 54, 66, 78 are nested, but do not contact each other, thereby preventing shorting. Each conductive spring contact 44, 54, 66, 78 is identically formed. Each conductive spring contact 44, 54, 66, 78 includes a rigid circular ring 96 having a plurality of flexible fingers 98 extending downward and inward from the ring 96. The rings 96 are mounted to the lower surfaces of the busbars 42, 52, 64, 76. The fingers 98 are spaced apart from each other around the circumference of the rings 96 and extend radially outward from the respective rings 96. Each finger 98 extends through the respective opening 84, 86, 88, 90 and downward of the lower surfaces of the busbars 38, 48, 60, 72. A lower end of each finger 98 of each spring contact 44, 54, 66, 78 engages with the positive terminal 30 of the respective battery cell 22 in the arrays AR1, AR2, AR3, AR4 when the fingers 98 are deflected as described herein.

The insulator 46, 56, 68, 80 may be formed as a separate member between the busbars 38, 42, 48, 52, 60, 64, 72, 76. The insulator 46, 56, 68, 80 may be formed as a laminate on the upper surfaces of the busbars 38, 48, 60, 64, 72 and/or the lower surfaces of the 42, 52, 64, 76. The insulator 46, 56, 68, 80 may additionally be on the walls forming the openings 84, 86, 88, 90. An insulator may be additionally provided on the lower surfaces of the busbars 38, 48, 60, 64, 72 and/or the upper surfaces of the 42, 52, 64, 76.

The connector 58 may be formed as a conductive fastener that extends through an extension of the second busbar 42 which overlaps an extension of the third busbar 48. The connector 70 may be formed as a conductive fastener that extends through an extension of the fourth busbar 52, a conductive fastener that extends through an extension of the fifth busbar 60, and an elongated conductive member which may be a busbar coupled to the conductive fasteners. The connector 82 may be formed as a conductive fastener that extends through an extension of the sixth busbar 64 which overlaps an extension of the seventh busbar 72.

The holding assembly 24 includes a rigid insulative holder 100 for each array AR1, AR2, AR3, AR4, a rigid cold plate 102 for each holder 100, a rigid insulative bracket 104 which is coupled to each for each array AR1, AR2, AR3, AR4, a first elongated member 106, which may be a fastener, coupling a first end of the cold plate 102 to the bracket 104 in each array AR1, AR2, AR3, AR4, and a second elongated member 108, which may be a fastener, coupling a second end of the cold plate 102 to the bracket 104 in each array AR1, AR2, AR3, AR4.

Each holder 100 includes a bottom plate 110 having a plurality of openings 112 therein in which the battery cells 22 of the respective array AR1, AR2, AR3, AR4 seat, a first end wall 114 at an end of the bottom plate 110, and a second side wall 116 at an opposite end of the bottom plate 110. The end walls 114, 116 abuts against the first and last columns of the battery cells 22 of the respective array AR1, AR2, AR3, AR4.

Each cold plate 102 seats against the lower surface of the respective bottom plate 110 and the planar lower end 36 of each battery cell 22 bears against the upper surface of the cold plate 102. The cold plate 102 assists in dissipating heat from the battery cells 22.

The bracket 104 for array AR1 engages against the upper surface of the busbar 42. The bracket 104 for array AR2 engages against the upper surface of the busbar 52. The bracket 104 for array AR3 engages against the upper surface of the busbar 64. The bracket 104 for array AR4 engages against the upper surface of the busbar 76.

When the members 106, 108 are tightened, the positions of the brackets 104 adjust to move the brackets 104 to bear against the busbars 42, 52, 64, 76, which deflects the flexible fingers 98 of the conductive spring contacts 44, 54, 66, 78 into engagement with the positive terminals 30 and deflects the fingers 94 of the conductive spring contacts 40, 50, 62, 74 into engagement with the negative terminals 32. The holding assembly 24 provides the appropriate amount of force for good electrical contact. The holding assembly 24 and the busbar assembly 20 can be easily disengaged from the arrays AR1, AR2, AR3, AR4 for reuse. The holder 100 accurately positions and datums all the components together.

Insulative pins and/or rivets 118 may be provided to locate the busbars 38, 42, the busbars 48, 52, the busbars 60, 64, the busbars 72, 76 and keep the busbars 38, 42, 48, 52, 60, 64, 72, 76 in place without shorting.

While particular embodiments are illustrated in and described with respect to the drawings, it is envisioned that those skilled in the art may devise various modifications without departing from the spirit and scope of the appended claims. It will therefore be appreciated that the scope of the disclosure and the appended claims is not limited to the specific embodiments illustrated in and discussed with respect to the drawings and that modifications and other embodiments are intended to be included within the scope of the disclosure and appended drawings. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the disclosure and the appended claims. Further, the foregoing descriptions describe methods that recite the performance of a number of steps. Unless stated to the contrary, one or more steps within a method may not be required, one or more steps may be performed in a different order than as described, and one or more steps may be formed substantially contemporaneously. Finally, the drawings are not necessarily drawn to scale.

We claim:

1. A busbar assembly comprising:
a first conductive busbar having an opening therethrough and a first spring contact extending therefrom;
a second conductive busbar having a second spring contact extending therefrom, wherein the second spring contact extends through the opening; and
an insulative member between the first and second conductive busbars,
wherein a plurality of the openings, the first spring contacts and the second spring contacts are provided.

2. The busbar assembly as defined in claim 1, wherein each second spring contact nests within the respective first spring contact.

3. The busbar assembly as defined in claim 1, wherein each second spring contact includes a plurality of flexible fingers which are spaced apart from each other.

4. The busbar assembly as defined in claim 3, wherein each second spring contact further includes a ring from which the plurality of flexible fingers extend.

5. The busbar assembly as defined in claim 3, wherein each first spring contact includes a plurality of flexible fingers which are spaced apart from each other, wherein the plurality of flexible fingers of each first spring contact surround the respective opening.

6. The busbar assembly as defined in claim 5, wherein each first spring contact further includes a ring from which the plurality of flexible fingers extend, the ring surrounding the respective opening.

7. The busbar assembly as defined in claim 1, wherein each first spring contact is configured to engage with a negative terminal of a battery cell, and each second spring contact is configured to engage with a positive terminal of the respective battery cell.

8. The busbar assembly as defined in claim 1, further including an insulative bracket engaged against the second busbar, wherein a position of the insulative bracket can be adjusted relative to the first busbar.

9. The busbar assembly as defined in claim 8, further including an insulative bottom plate which is configured to hold battery cells therein, and members coupling the bracket to the bottom plate.

10. The busbar assembly as defined in claim 9, wherein the members are adjustable to move the position of the bracket relative to the first busbar.

11. The busbar assembly as defined in claim 9, further including a cold plate engaged against an end of each battery cell, the cold plate assisting in dissipating heat from the battery cells.

12. The busbar assembly as defined in claim 1, wherein an input electrically coupled to the first busbar, and an output electrically coupled to the second busbar.

13. The busbar assembly as defined in claim 1, further comprising:
an input electrically coupled to the first busbar;
a third conductive busbar having an opening therethrough and a third spring contact extending therefrom;
a fourth conductive busbar having a fourth spring contact extending therefrom, wherein the fourth spring contact extends through the opening in the third conductive busbar; and
an insulative member between the third and fourth conductive busbars,
wherein a plurality of openings in the third conductive busbar, the third spring contacts and the fourth spring contacts are provided; and
a coupling electrically connecting the second busbar to the third busbar.

14. The busbar assembly as defined in claim 13, wherein an output is electrically coupled to the third busbar.

15. The busbar assembly as defined in claim 13, further comprising:
a fifth conductive busbar having an opening therethrough and a fifth spring contact extending therefrom;
a sixth conductive busbar having a sixth spring contact extending therefrom, wherein the sixth spring contact extends through the opening in the fifth conductive busbar; and
an insulative member between the fifth and sixth conductive busbars,
wherein a plurality of openings in the fifth conductive busbar, the fifth spring contacts and the sixth spring contacts are provided; and
a coupling electrically connecting the fourth busbar to the fifth busbar.

16. The busbar assembly as defined in claim 15, wherein an output is electrically coupled to the fifth busbar.

17. The busbar assembly as defined in claim 15, further comprising:
a seventh conductive busbar having an opening therethrough and a seventh spring contact extending therefrom;
an eighth conductive busbar having an eighth spring contact extending therefrom, wherein the eighth spring contact extends through the opening in the seventh conductive busbar; and
an insulative member between the seventh and eighth conductive busbars,
wherein a plurality of openings in the seventh conductive busbar, the seventh spring contacts and the eighth spring contacts are provided; and
a coupling electrically connecting the sixth busbar to the seventh busbar.

18. The busbar assembly as defined in claim 17, wherein an output is electrically coupled to the seventh busbar.

19. A busbar assembly comprising:
a first conductive busbar having an opening therethrough and a first spring contact extending therefrom;
an input electrically coupled to the first busbar;
a second conductive busbar having a second spring contact extending therefrom, wherein the second spring contact extends through the opening and nests within the first spring contact;
an insulative member between the first and second conductive busbars,
wherein a plurality of the openings, the first spring contacts and the second spring contacts are provided, each first spring contact is configured to engage with a negative terminal of a respective battery cell of a first array of battery cells, and each second spring contact is configured to engage with a positive terminal of the respective battery cell;
a third conductive busbar having an opening therethrough and a third spring contact extending therefrom;
a fourth conductive busbar having a fourth spring contact extending therefrom, wherein the fourth spring contact extends through the opening in the third conductive busbar and nests within the third spring contact; and
an insulative member between the third and fourth conductive busbars, wherein a plurality of openings in the third conductive busbar, the third spring contacts and the fourth spring contacts are provided; each third spring contact is configured to engage with a negative terminal of a respective battery cell of a second array of battery cells, and each fourth spring contact is configured to engage with a positive terminal of the respective battery cell of the second array;
a coupling electrically connecting the second busbar to the third busbar;
an output electrically coupled to the third busbar;
a first insulative bracket engaged against the second busbar, wherein a position of the first insulative bracket can be adjusted relative to the first busbar; and
a second insulative bracket engaged against the fourth busbar, wherein a position of the second insulative bracket can be adjusted relative to the third busbar.

20. The busbar assembly as defined in claim 19, further comprising at least one insulative bottom plate which is configured to hold the arrays battery cells therein, members coupling the brackets to the bottom plate, wherein the members are adjustable to move the position of the respective brackets, and a cold plate engaged against an end of each battery cell, the cold plate assisting in dissipating heat from the battery cells.
